(19) United States
(12) Patent Application Publication
(10) Pub. No.: US 2021/0103869 A1
(43) Pub. Date: Apr. 8, 2021

(54) SYSTEM AND A METHOD FOR OPTIMIZING SOLUTION IDENTIFICATION FOR A PROBLEM

(71) Applicant: Cognizant Technology Solutions India Pvt. Ltd., Chennai (IN)

(72) Inventors: Hari Saravanabhavan, Bangalore (IN); Chandrasekhar Balasubramanyam, Bangalore (IN)

(21) Appl. No.: 16/695,579

(22) Filed: Nov. 26, 2019

(30) Foreign Application Priority Data
Oct. 4, 2019 (IN) 201941040294

(51) Int. Cl. G06Q 10/06; G06Q 30/02

(52) U.S. Cl. CPC G06Q 10/06313; G06Q 10/0635; G06Q 30/0202

(57) ABSTRACT

A system and method for optimizing solution identification for a data analytics problem is provided. The present invention provides for rendering multiple standard use cases associated with one or more data analytics problems. Standard use case is flagged from amongst the multiple standard use cases for analysis. Further, analyzing the flagged standard use case based on corresponding set of algorithms from pre-defined set of algorithms for determining sub-category of standard use case. Further, performing check to determine availability of in-built solution for solving one or more data analytics problems of the determined sub-category of standard use case based on corresponding set of algorithms from pre-defined set of algorithms. Finally, generating alert for development of one or more solutions to the problems related to determined sub-category of standard use case if built-in solution is not found. A solution is received from external developed solutions in response to alert.

### FIELD OF THE INVENTION

The present invention relates generally to the field of data processing and analytics. More particularly, the present invention relates to a system and a method for optimizing solution identification for a problem relating to data analytics.

### BACKGROUND OF THE INVENTION

Multiple users utilizing large volumes of data for analytics purposes in an organization may come across data analytics problems for which they may require solutions. The problems may include, but are not limited to, operational data analysis, risk and fraud detection data analysis, customer data analysis, product data analysis, business data analysis etc. The users may require desired solutions for the problems depending upon their needs and requirements. The users seeking solutions for their data analytics problems are usually dependent upon one or more service providers for problem resolution. The service providers may be a third party offering solution for a required data analytics problem, a freelancer individual etc. Conventionally, the users seeking solutions may have access to a limited number of solution providers, that fails to efficiently and effectively satisfy the needs and requirements of the users and therefore users are not able to choose a service provider according to their needs and requirements. Further, the users typically dependent on a particular solution provider, may not have access to other solution providers that may be capable of adequately providing solution for the problem according to user's needs and requirements. Further, a problem may require more than one type of solution for effective resolution and it has been observed that traditional systems are not able to provide the same. Further, it has been observed that the solution providers are not able to always provide the required solution in real-time to the users.

In light of the aforementioned drawbacks, there is a need for a system and a method which optimizes solution identification for a data analytics problem. Further, there is a need for a system and a method which provides an appropriate solution to the user by efficiently catering to the needs and requirements of the users by providing data democratization functionality. Further, there is a need for a system and a method which provides solution to a user in real-time.

### SUMMARY OF THE INVENTION

In various embodiments of the present invention, a system for solution identification for a data analytics problem in real-time is provided. The system interfaces with an input/output unit and an updating subsystem. The system comprises a memory storing program instructions, a processor configured to execute instructions stored in the memory and a solution optimization engine executed by the processor and configured to render multiple standard use cases associated with one or more data analytics problems. A standard use case is flagged from amongst the multiple standard use cases for analysis. Further, the system is configured to analyze the flagged standard use case based on a corresponding set of algorithms from a pre-defined set of algorithms for determining a sub-category of the standard use case. Further, the system is configured to perform a check to determine availability of an in-built solution for solving the one or more data analytics problems of the determined sub-category of the standard use case based on the corresponding set of algorithms from the pre-defined set of algorithms. Finally, the system is configured to generate an alert for development of one or more solutions to the problems related to the determined sub-category of the standard use case if the built-in solution is not found. A solution is received from external developed solutions in response to the alert.

In various embodiments of the present invention, a method for solution identification for a data analytics problem in real-time is provided. The method is executed by a processor implementing instructions stored in a memory. The method comprises rendering multiple standard use cases associated with one or more data analytics problems. A standard use case is flagged from amongst the multiple standard use cases for analysis. The method further comprises analyzing the flagged standard use case based on a corresponding set of algorithms from a pre-defined set of algorithms for determining a sub-category of the standard use case. Further, the method comprises performing a check to determine availability of an in-built solution for solving the one or more data analytics problems of the determined sub-category of the standard use case based on the corresponding set of algorithms from the pre-defined set of algorithms. Finally, the method comprises generating an alert for development of one or more solutions to the problems related to the determined sub-category of the standard use case if the built-in solution is not found. A solution is received from external developed solutions in response to the alert.

In various embodiments of the present invention, a computer program product is provided. The computer program product comprises a non-transitory computer-readable medium having computer-readable program code stored thereon, the computer-readable program comprising instructions that, when executed by the processor, causes the processor to render multiple standard use cases associated with one or more data analytics problems. A standard use case is flagged from amongst the multiple standard use cases for analysis. Further, the flagged standard use case is analyzed based on a corresponding set of algorithms from a pre-defined set of algorithms for determining a sub-category of the standard use case. Further, a check is performed to determine availability of an in-built solution for solving the one or more data analytics problems of the determined sub-category of the standard use case based on the corresponding set of algorithms from the pre-defined set of algorithms. Finally, an alert is generated for development of one or more solutions to the problems related to the determined sub-category of the standard use case if the built-in solution is not found. A solution is received from external developed solutions in response to the alert.

### BRIEF DESCRIPTION OF THE ACCOMPANYING DRAWINGS

The present invention is described by way of embodiments illustrated in the accompanying drawings wherein:

FIG. 1 is a detailed block diagram of a system for optimizing solution identification for a data analytics problem, in accordance with various embodiments of the present invention;

FIG. 2 is a flowchart illustrating a method for optimizing solution identification for a data analytics problem, in accordance with various embodiments of the present invention; and

FIG. 3 illustrates an exemplary computer system in which various embodiments of the present invention may be implemented.

### DETAILED DESCRIPTION OF THE INVENTION

The present invention discloses a system and a method for optimizing solution identification for a data analytics problem by providing required solution to a user and further connecting the user to an appropriate service provider, which may provide solution according to the needs and requirements of the users. The present invention provides for a self-optimizing system which has a built-in-intelligent mechanism for assessing and analyzing the data analytics problem type, analyzing the requirements of the user, providing the required solution and connecting the user to an appropriate solution provider for problem resolution. The present invention further provides for choosing an appropriate service provider by the user from a combination of service providers with respect to his needs and requirements. The present invention provides for problem resolution in real-time.

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purposes of clarity, details relating to technical material that is known in the technical fields related to the invention have been briefly described or omitted so as not to unnecessarily obscure the present invention.

The present invention would now be discussed in context of embodiments as illustrated in the accompanying drawings.

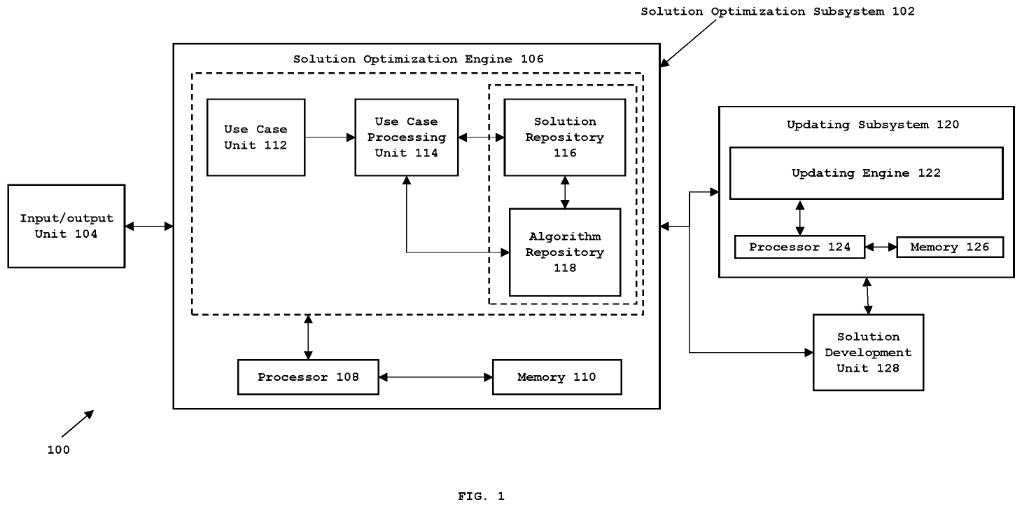

FIG. 1 is a block diagram of a solution optimization system 100 for optimizing solution identification for a data analytics problem arising in an organization, in accordance with various embodiments of the present invention. Referring to FIG. 1, in an embodiment of the present invention, the system 100 comprises a solution optimization subsystem 102, an input/output unit 104, an updating subsystem 120 and a solution development unit 128.

In an embodiment of the present invention, the solution optimization subsystem 102 comprises a solution optimization engine 106, a processor 108 and a memory 110. In various embodiments of the present invention, the solution optimization engine 106 has multiple units which work in conjunction with each other for assessing the data analytics problem received from the user and providing a specific solution for the assessed problem. The various units of the solution optimization engine 106 are operated via the processor 108 specifically programmed to execute instructions stored in the memory 110 for executing respective functionalities of the units of the solution optimization engine 106 in accordance with various embodiments of the present invention.

In another embodiment of the present invention, the subsystem 102 and subsystem 120 may be implemented in a cloud computing architecture in which data, applications, services, and other resources are stored and delivered through shared data-centers. In an exemplary embodiment of the present invention, the functionalities of the subsystem 102 and subsystem 120 are delivered to a user as software as a service (SaaS) over a communication network.

In another embodiment of the present invention, the subsystem 102 and subsystem 120 may be implemented as a client-server architecture. In said embodiment of the present invention, a client terminal accesses a server hosting the subsystem 102 and subsystem 120 over a communication network. The client terminals may include but are not limited to a smart phone, a computer, a tablet, microcomputer or any other wired or wireless terminal. The server may be a centralized or a decentralized server.

In an embodiment of the present invention, the solution optimization engine 106 is configured to receive user's data analytics problem via the input/output unit 104. The solution optimization engine 106 is configured to receive multiple data analytics problems from multiple users via the multiple input/output units 104. The users problem received may be in a form of a structured dataset or an unstructured dataset or without any dataset inputs. The input/output unit 104 may include, but are not limited to, a laptop, a computer system, a smart phone, a tablet, a graphical user interface (GUI) etc. The input/output unit 104 is connected to the solution optimization engine 106 via a communication channel (not shown). The communication channel (not shown) may include, but is not limited to, a physical transmission medium, such as, a wire, or a logical connection over a multiplexed medium, such as, a radio channel in telecommunications and computer networking. The examples of radio channel in telecommunications and computer networking may include, but are not limited to, a local area network (LAN), a metropolitan area network (MAN) and a wide area network (WAN). The input/output unit 104 may be associated with a user in an organization. The user may be an individual in an organization utilizing large volumes of data for data analytics purpose.

In an exemplary embodiment of the present invention, the user's problem is representative of a data analytics requirement, which may include, but is not limited to, a report generation relating to different business requirements, gathering raw data for analytics purposes, a specific model requirement for data analysis, inventory utilization analysis, resources utilization analysis, market analysis etc.

In an embodiment of the present invention, the solution optimization subsystem 102 is integrated with the users input/output unit 104 by registering the users input/output unit 104 in order to receive one or more use cases from the one or more users. The solution optimization subsystem 102 is configured to assess each user before providing solution resolution functionalities and registration of the user input/output unit 104. Further, users are assessed based on user details, use case scenarios, needs and requirements and prediction of an output for the users use case resolution. The solution optimization subsystem 102 generates a unique identification number for registering each user associated with the input/output unit 104 after assessment. The solution optimization subsystem 102 is further configured to provide the generated unique identification number via a GUI on the users' input/output unit 104. The user may utilize the generated unique identification number for accessing the functionalities of the solution optimization subsystem 102 via the input/output unit 104 for resolution of one or more use cases. The unique identification number generated is therefore utilized to register the user and integrate the user and the user's input/output unit 104 with the solution optimization subsystem 102. The solution optimization subsystem 102 is configured to maintain a storage database (not shown) comprising the user details and the unique identification number assigned to each user. The storage database (not shown) may be at a location local or remote to the solution optimization subsystem 102.

In an embodiment of the present invention, the solution optimization engine 106 with in the solution optimization subsystem 102 is a self-optimizing and a self-learning engine which has a built-in-intelligent mechanism for providing solution to user's problem based on the user's needs and requirements. The solution optimization engine 106 utilizes various cognitive techniques such as, but are not limited to, artificial intelligence, machine learning etc. for assessing the problem received from the user, providing the user with an appropriate solution after assessing the problem or connecting the user to an appropriate solution provider, if the required solution is not available with the subsystem 102.

In an embodiment of the present invention, the solution optimization engine 106 comprises a use case unit 112, a use case processing unit 114, a solution repository 116 and an algorithm repository 118. The solution repository 116 and the algorithm repository 118 may be operated as one unit in accordance with various embodiments of the present invention.

In an embodiment of the present invention, the use case unit 112 is built-in with one or more standard use cases which are updated from time to time. In operation, the user may invoke the use case unit 112 of the solution optimization engine 106 via the input/output unit 104 by providing the data analytics problem relating to a data analytics requirement of a particular industry or domain. The use case unit 112 is configured to provide the built-in one or more standard use cases based on the industry or domain related to the data analytics problem to the users via the input/output unit 104. The built-in one or more standard use cases are provided to the users by the use case unit 112 upon being invoked via the GUI on the input/output unit 104 which may be an interactive GUI. The standard use cases may include, but are not limited to, operational intelligence, product intelligence, risk and fraud intelligence, customer behavior intelligence, business management intelligence, demand management, delivery governance, value management, consumption management, optimization intelligence, reputation intelligence, pattern detection intelligence etc. For example, if a domain or industry relates to retail, then standard use cases may include, but are not limited to, customer persona mapping, behavior analytics, in-store-personalization, supply chain analytics, target marketing report generation etc. The user may select, via the GUI, a most suitable use case associated with a particular industry according to his needs and requirements for which a solution is required. The user may further provide data related to selected use case and use case description after selecting the appropriate standard use case. The selected standard use case, with the use case data and description, is further flagged in the use case unit 112 for distinguishing the selected standard use case from other available and built-in standard use cases. The standard use cases built-in the use case unit 112 are updated and modified from time to time depending upon the needs and requirements of the users and the emerging data analytics requirements for a particular industry.

In an embodiment of the present invention, the use case processing unit 114 is configured to receive the flagged standard use case from the use case unit 112. The flagged standard use case is representative of a use case for which a solution is required. The use case processing unit 114 is configured to analyze the received flagged standard use cases for determining and matching the type of the standard use case with similar standard use cases that are built-in and stored in the use case unit 112. The use case processing unit 114 is configured to analyze and match flagged standard use case with a similar standard use case by utilizing a corresponding set of algorithms from a pre-defined set of algorithms that may have been previously utilized for analyzing a similar standard use case with respect to the use cases stored in the use case unit 112. The pre-defined set of algorithms comprises at least one of data processing instructions and data transformation instructions. The pre-defined set of algorithms are retrieved from the data analytics problems or use cases that were previously analyzed and the extracted algorithms are stored in the algorithm repository 118 which are subsequently extracted by the use case processing unit 114 for processing and analyzing the similar standard use cases. The type of the standard use cases may provide a sub-categorization of the standard use case processed and analyzed by the use case processing unit 114 for determining the data analytics requirement associated with the standard use case. The sub-categories of standard use cases may include, but are not limited to, analytics, visualization, optimization, machine learning, big data, master data management and data quality etc. Therefore, the standard use case may relate to one or more sub-categories. For example, a standard use case relating to product intelligence may be sub-categorized for determining the data analytics requirement associated with the standard use case which may include, but is not limited to, analytics, master data management and data quality etc. Further, the sub-categorization of standard use cases aids in providing the solution in required format for the standard use cases. The required form may include, but is not limited to, analytical format, predictive format, optimization format etc.

In an exemplary embodiment of the present invention, the set of algorithms utilized for analyzing the standard use cases are stored in the algorithm repository 118. The algorithms in the algorithm repository 118 may comprise multiple data processing and analyzing algorithms which may be generated based on empirical study of use case data collected from prior experimentation, data collected from various data analytics ecosystems and data collected based on learning patterns developed over a period of time. In another exemplary embodiment of the present invention, the pre-defined set of algorithms in the algorithm repository 118 comprises multiple sets of data processing and analyzing algorithms that aids in determination and matching of the standard use cases in the use case unit 112 for analyzing the needs and requirements of the users associated with the data analytics problem. For example, the data processing and analyzing algorithms may include, but are not limited to, Naïve Bayes algorithm, Hidden Markov algorithm, logistic regression algorithm, linear regression algorithm, random forest algorithm, neural network algorithm, k-nearest neighbor (KNN) algorithm, natural language processing (NLP) algorithm, XG Boost, support vector machine (SVM) algorithm, autoregressive integrated moving average (ARIMA) algorithm etc. A particular set of pre-defined algorithms, depending upon the user's needs and requirements, is fetched and utilized at a particular time by the use case processing unit 114 for analyzing the standard use case. For example, if a user's problem relates to determining probabilistic patterns in datasets relating to customer persona in a retail industry or domain, then Naïve Bayes algorithm may be fetched and utilized by the use case processing unit 114. The pre-defined set of algorithms in the algorithm repository 118 are updated by the subsystem 102 periodically each time a use case is analyzed, for facilitating efficient determination and matching of the use cases. Further, the algorithm repository 118 is configured to organize the pre-defined set of algorithms present therein with respect to the sub-categories of the standard use cases, relating to a domain or industry, that may have been previously analyzed. For example, if an industry is banking and finance services, then one or more standard use cases may include, but are not limited to, consumer lending, asset and wealth management, retail and wholesale etc. and a sub-category of the standard use case such as asset and wealth management may include, but is not limited to, anti-money laundering analytics etc. Therefore, the one or more pre-defined set of algorithms relating to or utilized for anti-money laundering analytics are organized under such sub-category.

In an embodiment of the present invention, the solution repository 116 is invoked by the use case processing unit 114 for automatically fetching a most appropriate solution from the solution repository 116 relating to the analyzed standard use case. The solution repository 116 is a database of multiple solutions stored thereon. The solutions in the solution repository 116 is updated from time to time and operates in conjunction with the algorithm repository 118. The solution repository 116, upon receiving a request from the use case processing unit 114 for determining and fetching the most appropriate solution for the analyzed standard use case, fetches and provides a most appropriate solution for the standard use case to the user by operating in conjunction with the algorithm repository 118 which utilizes the corresponding set of algorithms from the pre-defined set of algorithms for solution identification. In another embodiment of the present invention, the algorithms in the algorithm repository 118 are computed for developing a solution for the analyzed standard use case which are subsequently stored in the solution repository 116 for future retrieval. In yet another exemplary embodiment of the present invention, the pre-defined set of algorithms in the algorithm repository 118 may relate to algorithms that aid in determining the most appropriate solution from the stored built-in solutions for the analyzed standard use case. For example, the pre-defined se of algorithms may include, but are not limited to, Naïve Bayes algorithm, Hidden Markov algorithm, logistic regression algorithm, linear regression algorithm, random forest algorithm, neural network algorithm, k-nearest neighbor (KNN) algorithm, natural language processing (NLP) algorithm, XG Boost, support vector machine (SVM) algorithm, autoregressive integrated moving average (ARIMA) algorithm etc. Further, the algorithm repository 118 upon being invoked by the solution repository 116 firstly determines the category of the algorithm which is to be computed for fetching the built-in solution from the solution repository 116 for the analyzed use case. The category of the algorithm chosen is based on the type of the use case. The category of the algorithm may include, but is not limited to, data optimization algorithm, prediction analysis algorithm, machine learning algorithm, exploratory data analysis algorithm etc. Secondly, the algorithm type is selected by the algorithm repository 118 based on the category of the algorithm. For example, if category is prediction analysis algorithm, then type of the algorithm may include, but is not limited to, Naïve Bayes algorithm, Hidden Markov algorithm etc. Lastly, an appropriate algorithm model is selected utilizing which the algorithm is implemented. The algorithm model may include, but is not limited to, predictive model markup language (PMML), plain old java object (POJO), java script object notation (JSON) etc. Therefore, the algorithm repository 118 implementing the determined and selected algorithm category, type and model causes the solution repository 116 to appropriately and effectively select a solution for the use case type.

Further, one or more algorithms in the algorithm repository 118 are utilized by the solution repository 116 for periodically ranking the best solution from the built-in solutions with respect to the one or more use cases based on the accuracy of the solution provided for a particular use case. Further, one or more solutions may be built on one or more technology platforms such as, but are not limited to, python, java, C++, AZURE, MATLAB etc. for a particular use case. The technology platform represents one or more computer programing languages. Therefore, it should be appreciated that the subsystem 102 provides solution for the use case without any human intervention, for example, creating a report for revenue generation, risk management analysis, customer propensity analysis, revenue optimization, forecasting warranty claims, sales prediction analysis etc.

In an exemplary embodiment of the present invention, a detailed statement of the use case resolution is further generated by the subsystem 102 and provided to the user via the input/output unit 104. The statement may comprise information regarding, but is not limited to, the type of the use case analyzed, the industry to which the use case may relate, the solution provided, the algorithms utilized for analyzing the use case and determining the appropriate solution for the use case, the effectiveness of the solution in resolving the use case, the effectiveness of the algorithm in analyzing the use case and determining the appropriate solution for the use case, the technology platform utilized on which the solution is built, the application of a particular algorithm for different use case solution determination etc.

In another embodiment of the present invention, the user may provide a data analytics problem along with description that may not match with the standard uses cases present in the use case unit 112 and is therefore treated as a new use case, for example, developing a classifier for identifying a patient with a disease based on data from diagnosis etc. The use case processing unit 114 is unable to analyze the new data analytics problem. The user is notified by the subsystem 102 via the input/output unit 104 regarding the new data analytics problem. In various embodiment of the present invention, the solution optimization subsystem 102 is configured to invoke the updating subsystem 120 upon receiving the new data analytics problem. The updating subsystem 120 operates in conjunction with the solution optimization subsystem 102. The updating subsystem 120 may be at a location local or remote to the solution optimization subsystem 102.

In an embodiment of the present invention, the updating subsystem 120 comprises an updating engine 122, a processor 124 and a memory 126. In various exemplary embodiments of the present invention, the updating engine 122 comprises a storage unit (not shown), a kernel support unit (not shown), a graphic processing unit (GPU) (not shown), a tensor processing unit (TPU) (not shown), which work in conjunction with each other for assessing the new use case and updating the solution optimization subsystem 102 with the required solution of the new use case. The various units of the updating engine 122 are operated via the processor 124 specifically programmed to execute instructions stored in the memory 126 for executing respective functionalities of the units of the updating engine 122 in accordance with various embodiments of the present invention.

In an exemplary embodiment of the present invention, the updating subsystem 120 is invoked by the solution optimization engine 106 for providing notification in the form of alerts with regard to the new data analytics problem to one or more solution providers or solution developers via the solution development unit 128. The new data analytics problem is associated with the new use case. The new data analytics problem is further determined as a new use case by the updating subsystem 120 based on comparing the number of variables associated with the new data analytics problem with respect to variables associated with the already existing similar data analytics problem (use case) with respect to a pre-determined variable range. For instance, if an existing data analytics problem (use case) is associated with 15 variables and the new data analytics problem is associated with 30 variables and the pre-determined range of number of variables is 20 to 25 variables, then the new data analytics problem is processed as a new use case. For example, the data analytics problem may relate to an inventory management. The variables associated with the inventory management may be 5 and relates to number of items in the inventory, types of items in the inventory, sale and demand of items present in the inventory, size of the inventory, distance of the inventory from the vendor's place etc. However, the variables may vary for different data analytics problem (use case). Therefore, if a data analytics problem relating to inventory management comprises 4 new variables in addition to 5 existing variables and the pre-determined range of number of variables is 6, then it is analyzed as a new data analytics problem. Further, the variables may be classified as types of variables in the data analytics problem and total number of variables in the data analytics problem. For example, the data analytics problem may relate to an inventory management. The types of variables associated with the inventory management may relate to number of items in the inventory, types of items in the inventory, sale and demand of items present in the inventory, size of the inventory, distance of the inventory from the vendor's place etc. and the number of variables is 5 or more. The types of variables may be further classified into fundamental variables and derived variables. Fundamental variables are those variables which does not depend upon other variables associated with the use case. For example, if the use case relates to inventory management, then the fundamental variable may include cost of the items in the inventory, as the cost of items is not dependent on other variables. Further, derived variables are those variables which are dependent upon other variables. For example, if the use case relates to inventory management, then the derived variable may include distance of inventory from the purchaser and the time of supply of the items from inventory to the purchaser as the distance and time are directly related. The alert signifies to the solution providers or solution developers that a solution for the new data analytics problem needs to be developed. The alert may include, but is not limited to, a hackathon invite, a crowd sourcing process etc. The alerts are sent only to the registered solution providers or solution developers. The solution provider or solution developer are registered by the updating subsystem 120 via the solution development unit 128. The updating subsystem 120 is configured to assess the solution providers and solution developers before registration based on their capability of resolving a particular data analytics problem, their experience in solving data analytics problems using machine learning or artificial intelligence techniques etc.

The solution providers or solution developers upon receiving the alert may develop a solution according to the needs and requirements of the users with respect to the new data analytics problem. Further, one or more solutions may be developed by multiple solution providers or developers. The solution providers and solution developers develops the solution for a use case utilizing one or more pre-determined set of algorithms on various technology platforms such as, but are not limited to, Python, MATLAB, AZURE ML etc. The alerts for new solution generation and the solution development by the solution providers and solution developers is carried out in real-time. Further, one or more solution providers and developers may develop one or more solution for a particular data analytics problem utilizing one or more technology platforms. For example, for a data analytics problem relating to optimization intelligence, the solution providing optimization analysis may be developed utilizing python or MATLAB technology or AZURE technology etc.

Further, the updating subsystem 120 is configured to receive the one or more solutions developed by the solution providers or developers via the one or more solution development unit(s) 128. The updating engine 122 of the subsystem 120 is further configured to analyze the received one or more solutions for identifying a most suitable new solution with respect to the new data analytics problem. The new solutions are analyzed based on the accuracy in solving the data analytics problem utilizing sorting or filtering techniques. The updating subsystem 120 thereafter communicates with the solution optimization subsystem 102 for providing the most suitable new solution with respect to the new data analytics problem to the solution optimization engine 106. The new solution is received and further assessed by the solution optimization engine 106 for determining its effectiveness in solving the new data analytics problem before being fed to the solution repository 116 for updating the solution repository 116 with the new solution. The solution is assessed and ranked based on its accuracy in solving a data analytics problem utilizing an automated or manual technique. The assessed new solution is therefore updated and stored in the solution repository 116. Further, the algorithm repository 118 is updated with the algorithms which are utilized by the solution providers and developers on the technology platform and which may be further utilized for faster and efficient identification of the similar solution with regard to the respective new data analytics problem. Further, the algorithm utilized by the solution provider and developer is updated in the algorithm repository 118 for appropriate indexing. The indexing of the algorithm is carried out automatically based on the effectiveness of the algorithm in resolving a data analytics problem associated with a particular industry in a matrix form. The indexing of the algorithm aids in determining the functionality of the algorithm for solving a data analytics problem for a particular industry. The matrix may comprise different criterion such as, but are not limited to, ranking of different types of algorithms according to their accuracy in solving a particular use case, the preference of users for an algorithm in solving the use case, percentage of use case resolution correctly by an algorithm, acceptance of an algorithm by the users etc. Further, more than one matrix may be formed based on different criterion. The new solution updated in the solution repository 116 is thereafter provided to the user via the input/output unit 104 by the solution optimization subsystem 102.

In another embodiment of the present invention, the solution optimization subsystem 102 is configured to connect the one or more users directly to the solution providers or developers via the solution development unit 128 upon receiving the data analytics problem from the one or more users. The solution optimization subsystem 102 is further configured to provide plug-ins for communication via the solution development unit 128 to computational open-source technologies such as, but are not limited to, R, PYTHON, C++, Java and its variants etc. and commercial technologies such as, but are not limited to, MATLAB, IBM WATSON, AZURE ML, DATA ROBOT etc. The use case unit 112 of the solution optimization engine 106 provides the built-in standard use cases to the users via the input/output unit 104. The standard use case is selected by the user via the GUI of the input/output unit 104 and is thereafter flagged in the use case unit 112. The selected and flagged standard use case is analyzed by the use case processing unit 114 in conjunction with the algorithm repository 118 based on the pre-defined algorithms. Further, the use case processing unit 114 after analysis of the data analytics problem, causes the solution optimization subsystem 102 to provide via the solution development unit 128 a list of appropriate open source technologies and most appropriate solution providers or developers to users based on a ranking technique. The list of appropriate open source technologies and most appropriate solution providers or developers are further provided based on the needs and requirement of the users for data analytics problem resolution along with the solution developers.

Further, the user may select the appropriate technology and the solution provider or developer via the GUI of the input/output unit 104 according to his needs and requirements. Thereafter, a notification is sent to the selected solution provider by the solution optimization subsystem 102 via the solution development unit 128 for developing the required solution. The solution developer may thereafter develop the solution in accordance with the technology selected by the user and communicate the developed solution to the user via the input/output unit 104 of the user via the solution optimization subsystem 102. In an exemplary embodiment of the present invention, the solution optimization subsystem 102 is configured to further recommend to the user the technology for solution development based on the data analytics problem analyzed by the use case processing unit 114 in conjunction with algorithm repository 118 utilizing the pre-determined set of algorithms. In another exemplary embodiment of the present invention, the solution optimization subsystem 102 is configured to recommend to the user, if multiple technologies are required for developing a particular solution with regard to the data analytics problem analyzed by the use case processing unit 114. The solution optimization subsystem 102 is further configured to communicate via the solution development unit 128 the technology selected by the user to solution developer for solution development. The solution developer may thereafter develop the required solution on the technology selected by user or the solution developer and communicate at least the developed solution or the outcome of solution in required form to the user via the solution optimization subsystem 102.

In an embodiment of the present invention, the solution optimization subsystem 102 is configured to maintain a secure connection between the users input/output device 104 with the updating subsystem 120 and the solution development unit 128. In an exemplary embodiment of the present invention, the solution optimization subsystem 102 may be configured with an operating system (OS) which may, at least, control traffic, maintains connectivity between users and the solution providers, connects users to external data providers, maintains users access controls, analytics supply etc.

Advantageously, in accordance with various embodiments of the present invention, the system 100 is configured with built-in intelligent mechanism which is capable of automatically assessing the needs and requirements of the users with regard to their data analytics problems for providing most appropriate solution in real-time. The solution optimization engine 106 of the subsystem 102 is configured to solve the users' data analytics problem by providing built-in solutions specific to the data analytics problem without any human intervention or connect the data sources of the users to the solution providers for communicating the use cases for data analytics problem resolution by solution developer. The system 100 provides faster and efficient throughput for resolution of the data analytics problems as it is updated with regard to the built-in solutions, algorithms for use case identification and fetching best built-in solution for the data analytics problems, users data sources, list of solution providers, open-source computing platforms etc. Further, the system 100 is updated based on learning patterns from time to time.

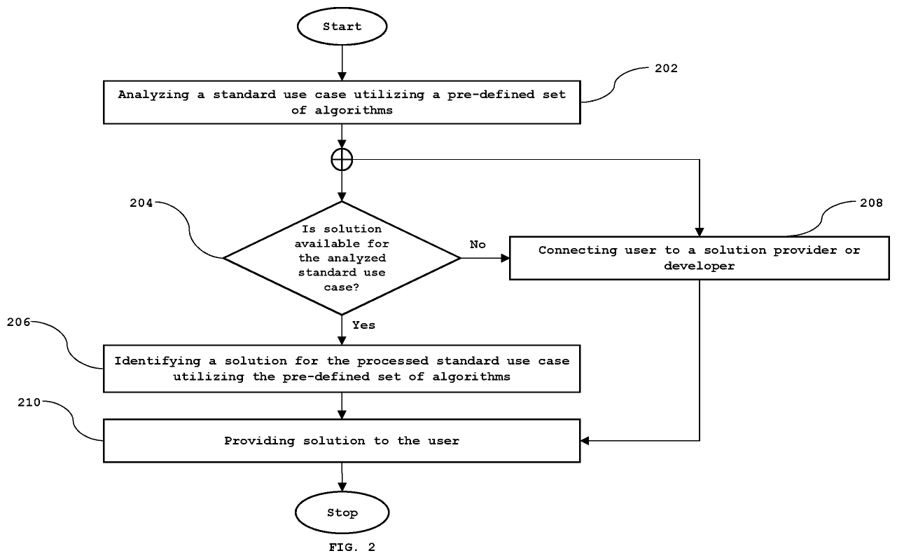

FIG. 2 is a flowchart illustrating a method for optimizing solution identification for a data analytics problem, in accordance with various embodiments of the present invention.

At step 202, a standard use case is analyzed utilizing a pre-defined set of algorithms. In various embodiment of the present invention, multiple data analytics problems are received from multiple users. The users problem received may be in a form of structured or unstructured dataset or no dataset inputs. The user may be an individual in an organization utilizing large volumes of data for data analytics purposes. In an exemplary embodiment of the present invention, the user's problem is representative of a data analytics requirement, which may include, but is not limited to, a report generation related to different business requirements, gathering raw data for analytics purposes, a specific model requirement for data analysis, inventory utilization analysis, resources utilization analysis, market analysis etc.

In an embodiment of the present invention, the user's input/output unit is registered in order to receive one or more use cases from the one or more users. Further, each user is assessed before providing solution resolution functionalities and registration of user input/output unit. Further, users are assessed based on user details, use case scenarios, needs and requirements and prediction of an output for the users use case resolution. A unique identification number is generated for registering each user after assessment. The user may utilize the generated unique identification number for accessing the functionalities of the subsystem for resolution of the one or more use cases. The unique identification number generated is therefore utilized to register the user and integrate the user and user's input/output unit with the system. The user details and the unique identification number assigned to each user are maintained in a storage database. The storage database may be at a location local or remote to the solution optimization subsystem.

In an embodiment of the present invention, the built-in one or more standard use cases are provided to the users. The one or more standard use cases are updated from time to time. In operation, the built-in one or more standard use cases based on the industry or domain related to the data analytics problem are provided to the users via the GUI on the input/output unit which may be an interactive GUI based on the received data analytics problem relating to a data analytics requirement of a particular industry or domain. The standard use cases may include, but are not limited to, operational intelligence, product intelligence, risk and fraud intelligence, customer intelligence, business intelligence, demand management, delivery governance, value management etc. For example, if a domain or industry relates to retail, then standard use cases may include, but are not limited to, customer persona mapping, behavior analytics, in-store-personalization, supply chain analytics, target marketing report generation etc. The user may select, via the GUI, a most suitable use case associated with a particular industry according to his needs and requirements for which may a solution is required. The user may further provide data related to selected use case and use case description after selecting the appropriate standard use case. The selected standard use case, with the use case data and description, is further flagged for distinguishing the selected standard use case from other available and built-in standard use cases. The built-in standard use cases are updated and modified from time to time depending upon the needs and requirements of the users and the emerging data analytics requirements for a particular industry.

In an embodiment of the present invention, the flagged standard use case is representative of a use case for which a solution is required. The flagged standard use cases are analyzed for determining and matching the type of the standard use case with built-in similar use cases. The flagged standard use cases are analyzed by utilizing a corresponding set of algorithms from a pre-defined set of algorithms that may have been previously utilized for analyzing a similar standard use case with respect to the stored use cases. The pre-defined set of algorithms comprises at least one of data processing instructions and data transformation instructions. The pre-defined set of algorithms are retrieved from the data analytics problems or use cases that were previously analyzed and stored in the algorithm repository which are subsequently extracted for analyzing a similar standard use case. The type of the standard use cases may provide a sub-categorization of the standard use case analyzed for determining the data analytics requirement associated with the standard use case. The sub-categories of standard use cases may include, but are not limited to, analytics, visualization, optimization, machine learning, big data, master data management and data quality etc. Therefore, the standard use case may relate to one or more sub-categories. For example, a standard use case relating to product intelligence may be sub-categorized for determining the data analytics requirement associated with the standard use case which may include, but are not limited to, analytics, master data management and data quality etc. Further, the sub-categorization of standard use cases aids in providing the solution in required format for the standard use cases. The required form may include, but is not limited to, analytical format, predictive format, optimization format etc.

In an exemplary embodiment of the present invention, the set of algorithms utilized for analyzing the standard use cases comprises multiple data processing and analyzing algorithms which may be generated based on empirical study of use case data collected from prior experimentation, data collected from various data analytics ecosystems and data collected based on learning patterns developed over a period of time. In another exemplary embodiment of the present invention, the pre-defined set of algorithms comprises data processing and analyzing algorithms that aids in determination and matching of the standard use cases for analyzing the needs and requirements of the users associated with the data analytics problem. For example, the pre-defined set of algorithms may include, but are not limited to, Naïve Bayes algorithm, Hidden Markov algorithm, logistic regression algorithm, random forest algorithm, neural network algorithm, KNN algorithm, natural language processing (NLP) algorithm, XG Boost, SVM etc. A particular set of pre-defined algorithms, depending upon the user's needs and requirements, is fetched and utilized at a particular time for analyzing the standard use case. For example, if a user's problem relates to determining probabilistic patterns in datasets relating to customer persona in a retail industry or domain, then Naïve Bayes algorithm may be fetched and utilized. The pre-defined set of algorithms are updated periodically each time a use case is analyzed, for facilitating determination and matching of the use cases efficiently. Further, the pre-defined set of algorithms are organized with respect to the sub-categories of the standard use cases, relating to a domain or industry, that may have been previously analyzed. For example, if an industry is banking and finance services, then one or more standard use cases may include, but are not limited to, consumer lending, asset and wealth management, retail and wholesale etc. and a sub-category of the standard use case such as asset and wealth management may include, but is not limited to, anti-money laundering analytics etc. Therefore, the one or more pre-defined set of algorithms relating to or utilized for anti-money laundering analytics are organized under such sub-category.

At step 204, a check is performed to determine if a solution is available for the analyzed standard use case. At step 206, a solution for the analyzed standard use case is identified utilizing the corresponding set of algorithms from the pre-defined set of algorithms if a solution is available for the analyzed standard use case. In an embodiment of the present invention, a most appropriate solution relating to the analyzed standard use case is automatically fetched. A most appropriate solution for the standard use case is fetched and provided to the user utilizing the corresponding set of algorithms from the pre-defined set of algorithms for solution identification. In another embodiment of the present invention, the pre-defined set of algorithms are computed for developing a solution for the analyzed standard use case which are subsequently stored in the solution repository for future retrieval. In yet another exemplary embodiment of the present invention, the pre-defined set of algorithms may relate to algorithms that aids in determining the most appropriate solution from the built-in solutions for analyzed standard use case. For example, the data processing and analyzing algorithms may include, but are not limited to, Naïve Bayes algorithm, Hidden Markov algorithm, logistic regression algorithm, linear regression algorithm, random forest algorithm, neural network algorithm, k-nearest neighbor (KNN) algorithm, natural language processing (NLP) algorithm, XG Boost, support vector machine (SVM) algorithm, autoregressive integrated moving average (ARIMA) algorithm etc. Further, the process of utilization of pre-defined set of algorithms for solution determination includes, firstly, determining the category of the algorithm which is to be computed for fetching the built-in solution for the analyzed use case. The category of the algorithm chosen is based on the type of the use case. The category of the algorithm may include, but is not limited to, data optimization algorithm, prediction analysis algorithm, machine learning algorithm, exploratory data analysis algorithm etc. Secondly, the algorithm type is selected for solution determination based on the category of the algorithm. For example, if category is prediction analysis algorithm, then type of the algorithm may include, but is not limited to, Naïve Bayes algorithm, Hidden Markov algorithm etc. Lastly, an appropriate algorithm model is selected utilizing which the algorithm is implemented. The algorithm model may include, but is not limited to, predictive model markup language (PMML), plain old java object (POJO), java script object notation (JSON) etc. Therefore, based on the implemented determined and selected algorithm category, type and model a solution for the use case type is appropriately and effectively selected.

The best solution from the built-in solutions are periodically ranked utilizing the one or more algorithms with respect to the one or more use cases based on the accuracy of the solution provided for a particular use case. Further, one or more solutions may be built on one or more technology platforms such as, but are not limited to, python, java, C++, AZURE, MATLAB etc. for a particular use case. The technology platform represents one or more computer programing languages. Further, at step 210, a solution for the use case is provided without any human intervention, for example, creating the report for revenue generation risk management analysis, customer propensity analysis, revenue optimization, forecasting warranty claims, sales prediction analysis etc.

In an exemplary embodiment of the present invention, a detailed statement of the use case resolution is further generated and provided to the user. The statement may comprise information regarding, but is not limited to, the type of the use case analyzed, the industry to which the use case may relate, the solution provided, the algorithms utilized for analyzing the use case and determining the appropriate solution for the use case, the effectiveness of the solution in resolving the use case, the effectiveness of the algorithm in analyzing the use case and determining the appropriate solution for the use case, the technology platform utilized on which the solution is built, the application of a particular algorithm for different use case solution determination etc.

At step 208, if solution for the analyzed use case is not available, user is connected to a solution provider or developer. In another embodiment of the present invention, the user may provide a data analytics problem along with description that may not match with the standard uses cases and is therefore treated as a new use case, for example, developing a classifier for identifying a patient with a disease based on data from diagnosis. The user is notified regarding the new data analytics problem. In an exemplary embodiment of the present invention, alerts are provided with regard to the new data analytics problem to one or more solution providers or solution developers. The new data analytics problem is associated with the new use case. The new data analytics problem is further determined as a new use case based on comparing the number of variables associated with the new data analytics problem with respect to variables associated with the already existing similar data analytics problem (use case) with respect to a pre-determined range of number of variables. For instance, if an existing data analytics problem (use case) is associated with 15 variables and the new data analytics problem is associated with 30 variables and the pre-determined range of number of variables is 20 to 25 variables, then the new data analytics problem is processed as a new use case. For example, the data analytics problem may relate to an inventory management. The variables associated with the inventory management may be 5 and relates to number of items in the inventory, types of items in the inventory, sale and demand of items present in the inventory, size of the inventory, distance of the inventory from the vendor's place etc. However, the variables may vary for different data analytics problem (use case). Therefore, if a data analytics problem relating to inventory management comprises 4 new variables in addition to 5 existing variables and the pre-determined range of number of variables is 6, then it is analyzed as a new data analytics problem. Further, the variables may be classified as types of variables in the data analytics problem and total number of variables in the data analytics problem. For example, the data analytics problem may relate to an inventory management. The types of variables associated with the inventory management may relate to number of items in the inventory, types of items in the inventory, sale and demand of items present in the inventory, size of the inventory, distance of the inventory from the vendor's place etc. and the number of variables is 5 or more. However, the variables may be different to different data analytics problem (use case). The types of variables may be further classified into fundamental variables and derived variables. Fundamental variables are those variables which does not depend upon other variables associated with the use case. For example, if the use case relates to inventory management, then the fundamental variable may include cost of the items in the inventory, as the cost of items is not dependent on other variables. Further, derived variables are those variables which are dependent upon other variables. For example, if the use case relates to inventory management, then the derived variable may include distance of inventory from the purchaser and the time of supply of the items from inventory to the purchaser as the distance and time are directly related. The alert signifies to the solution providers or solution developers that a solution for the new data analytics problem needs to be developed. The alert may include, but is not limited to, a hackathon invite, a crowd sourcing process etc. The alerts are sent only to the registered solution providers or solution developers. The solution providers and solution developers are assessed before registration based on their capability of resolving a particular data analytics problem, their experience in solving data analytics problems using machine learning or artificial intelligence techniques etc. The solution providers or solution developers upon receiving the alert may develop a solution according to the needs and requirements of the users with respect to the new data analytics problem. Further, one or more solutions may be developed by multiple solution providers or developers. The alerts for new solution generation and the solution development by the solution providers and solution developers is carried out in real-time. Further, one or more solution providers and developers may develop one or more solution for a particular data analytics problem utilizing one or more technology platforms. For example, for a data analytics problem relating to optimization intelligence, the solution providing optimization analysis may be developed utilizing python or MATLAB technology or AZURE technology etc.

Further, the one or more new solution developed by the solution providers or developers are analyzed for identifying a most suitable new solution with respect to the new data analytics problem. The new solutions are analyzed based on the accuracy in solving the data analytics problem utilizing sorting or filtering techniques. The new solution is further assessed for determining its effectiveness in solving the new data analytics problem. The solution is assessed and ranked based on its accuracy in solving a data analytics problem utilizing an automated or manual technique. The assessed new solution is therefore updated and stored. Further, the algorithms are updated which are utilized for faster and efficient identification of the similar solution with regard to the respective new data analytics problem. Further, the algorithm utilized by the solution provider and developer is updated for appropriate indexing. The indexing of the algorithm is carried out automatically based on the effectiveness of the algorithm in resolving a data analytics problem associated with a particular industry in a matrix form. The indexing of the algorithm aids in determining the functionality of the algorithm for solving a data analytics problem for a particular industry. The matrix may comprise different criterion such as, but are not limited to, ranking of different types of algorithms according to their accuracy in solving a particular use case, the preference of users for an algorithm in solving the use case, percentage of use case resolution correctly by an algorithm, acceptance of an algorithm by the users etc. Further, more than one matrix may be formed based on different criterion. Further, at step 210, the new solution updated is provided to the user.

In another embodiment of the present invention, after step 202 at step 208, the one or more users is connected directly to the solution providers or developers upon receiving the data analytics problem from the one or more users. Further, plug-ins are provided for communication to computational open-source technologies such as, but are not limited to, R, PYTHON, C++, Java and its variants etc. and commercial technologies such as, but are not limited to, MATLAB, IBM WATSON, AZURE ML, DATA ROBOT etc. The built-in standard use cases are provided to the users. The standard use case is selected by the user via the GUI and is thereafter flagged. The selected and flagged use case is analyzed based on the pre-defined set of algorithms. Further, after analysis of the use case the users are provided a list of appropriate open source technologies and most appropriate solution providers or developers according to the needs and requirement of the users for data analytics problem resolution along with the solution developers based on a ranking technique. The list of appropriate open source technologies and most appropriate solution providers or developers are further provided based on the needs and requirement of the users for data analytics problem resolution along with the solution developers

Further, the user may select the appropriate technology and the solution provider or developer via the GUI according to his needs and requirements. Thereafter, a notification is sent to the selected solution provider for developing the required solution. The solution developer may then develop the solution in accordance with the technology selected by the user or the solution developer and communicate the developed solution to the user. In an exemplary embodiment of the present invention, the technology for solution development is recommended to the user based on the data analytics problem analyzed utilizing the pre-determined set of algorithms. In another exemplary embodiment of the present invention, the user is recommended, if multiple technologies are required for developing a particular solution with regard to the use case analyzed. The technology selected by the user is communicated to the solution developer for solution development. Further, the solution developer may thereafter develop the required solution on the technology selected by the user and at step 210 at least the developed solution or the outcome of solution in required form is communicated to the user.

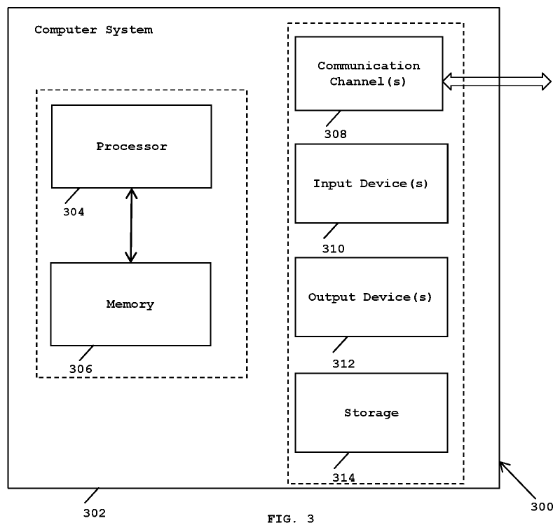

FIG. 3 illustrates an exemplary computer system in which various embodiments of the present invention may be implemented. The computer system 302 comprises a processor 304 and a memory 306. The processor 304 executes program instructions and is a real processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, Bluetooth or other transmission media.

The input device(s) 310 may include, but not limited to, a keyboard, mouse, pen, joystick, trackball, a voice device, a scanning device, touch screen or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, Bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as a system, a method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention.

We claim:

1. A system for solution identification for a data analytics problem in real-time, wherein the system interfaces with an input/output unit and an updating subsystem, the system comprising:
a memory storing program instructions;
a processor configured to execute instructions stored in the memory; and
a solution optimization engine executed by the processor and configured to:
render multiple standard use cases associated with one or more data analytics problems, wherein a standard use case is flagged from amongst the multiple standard use cases for analysis;
analyze the flagged standard use case based on a corresponding set of algorithms from a pre-defined set of algorithms for determining a sub-category of the standard use case;
perform a check to determine availability of an in-built solution for solving the one or more data analytics problems of the determined sub-category of the standard use case based on the corresponding set of algorithms from the pre-defined set of algorithms; and
generate an alert for development of one or more solutions to the problems related to the determined sub-category of the standard use case if the built-in solution is not found, wherein a solution is received from external developed solutions in response to the alert.

2. The system as claimed in claim 1, wherein the data analytics problem is at least in the form of a structured dataset, an unstructured dataset and without any dataset.

3. The system as claimed in claim 1, wherein the solution optimization engine comprises a use case unit configured to provide the standard use cases based on domain associated with the data analytics problem, the standard use case includes at least one of operational intelligence, product intelligence, risk and fraud intelligence, customer behavior intelligence, business management intelligence, demand management, delivery governance, value management, consumption management, optimization intelligence, reputation intelligence and pattern detection intelligence.

4. The system as claimed in claim 1, wherein the solution optimization engine comprises a use case processing unit configured to analyze the flagged standard use case for matching the type of the standard use case with similar standard use cases that are built-in a use case unit.

5. The system as claimed in claim 1, wherein the sub-category of the standard use case comprises data analytics requirement associated with the standard use case, and wherein the data analytics requirement includes at least one of analytics, visualization, optimization, machine learning, big data, master data management and data quality.

6. The system as claimed in claim 1, wherein the pre-defined set of algorithms comprises at least one of data processing instructions, data analyzing instructions and data transformation instructions stored in an algorithm repository which is configured to communicate with the use case processing unit for providing the pre-defined sets of algorithms for analyzing the standard use cases.

7. The system as claimed in claim 1, wherein the pre-defined set of algorithms are specific to the sub-category of the standard use cases.

8. The system as claimed in claim 1, wherein the algorithm repository is configured to organize the algorithms based on the sub-categories of the standard use cases, relating to a domain or industry, which are previously analyzed.

9. The system as claimed in claim 1, wherein the step of performing the check comprises identifying a solution from in-built solutions stored in a solution repository of the solution optimization engine for solving the problem associated with the standard use case, if the check is successful, based on the corresponding set of algorithms from the pre-defined set of algorithms.

10. The system as claimed in claim 1, wherein the pre-defined set of algorithms for determining the solution for solution identification includes, determining the category of the algorithm which is utilized for fetching the built-in solution for the analyzed use case, selecting an algorithm type for solution determination based on the category of the algorithm and selecting an appropriate algorithm model based on which the algorithm is utilized for solution identification.

11. The system as claimed in claim 1, wherein the data analytics problem is processed as a new use case by the updating subsystem 120 by comparing number of variables associated with the new data analytics problem based on one or more variables associated with the similar data analytics problem with respect to a pre-determined range of number of variables, if no built-in solution is available for the said data analytics problem.

12. The system as claimed in claim 1, wherein the updating subsystem is configured to receive one or more developed solutions from one or more solution development units and subsequently analyze the developed received solutions for selecting a solution from the developed solutions, based on a filtering technique, for resolving the data analytics problem.

13. A method for solution identification for a data analytics problem in real-time, the method comprising:
rendering, by a processor, multiple standard use cases associated with one or more data analytics problems, wherein a standard use case is flagged from amongst the multiple standard use cases for analysis;
analyzing, by the processor, the flagged standard use case based on a corresponding set of algorithms from a pre-defined set of algorithms for determining a sub-category of the standard use case;
performing a check, by the processor, to determine availability of an in-built solution for solving the one or more data analytics problems of the determined sub-category of the standard use case based on the corresponding set of algorithms from the pre-defined set of algorithms; and
generating, by the processor, an alert for development of one or more solutions to the problems related to the determined sub-category of the standard use case if the built-in solution is not found, wherein a solution is received from external developed solutions in response to the alert.

14. The method as claimed in claim 13, wherein the data analytics problem is at least in the form of a structured dataset, an unstructured dataset and without any dataset.

15. The method as claimed in claim 13, wherein the standard use cases are provided associated with domain related to the data analytics problem, the standard use case includes at least one of operational intelligence, product intelligence, risk and fraud intelligence, customer behavior intelligence, business management intelligence, demand management, delivery governance, value management, consumption management, optimization intelligence, reputation intelligence and pattern detection intelligence.

16. The method as claimed in claim 13, wherein the flagged standard use case is analyzed for matching the type of the standard use case with built-in similar standard use cases.

17. The method as claimed in claim 13, wherein the sub-category of the standard use case comprises data analytics requirement associated with the standard use case, and wherein the data analytics requirement includes at least one of analytics, visualization, optimization, machine learning, big data, master data management and data quality.

18. The method as claimed in claim 13, wherein the pre-defined set of algorithms comprises at least one of data processing instructions, data analyzing instructions and data transformation instructions utilized for analyzing the standard use cases.

19. The method as claimed in claim 13, wherein the pre-defined set of algorithms are specific to the sub-category of the standard use cases.

20. The method as claimed in claim 13, wherein the pre-defined set of algorithms are organized based on the sub-categories of the standard use cases, relating to a domain or industry, which are previously analyzed.

21. The method as claimed in claim 13, wherein the step of performing the check comprises identifying a solution from in-built solutions for solving the problem associated with the standard use case, if the check is successful, based on the corresponding set of algorithms from the pre-defined set of algorithms.

22. The method as claimed in claim 13, wherein the pre-defined set of algorithms for determining the solution for solution identification includes, determining the category of the algorithm which is utilized for fetching the built-in solution for the analyzed use case, selecting an algorithm type for solution determination based on the category of the algorithm and selecting an appropriate algorithm model based on which the algorithm is utilized for solution identification.

23. The method as claimed in claim 13, wherein the data analytics problem is processed as a new use case by comparing number of variables associated with the new data analytics problem based on one or more variables associated with the similar data analytics problem with respect to a pre-determined range of number of variables, if no built-in solution is available for the said data analytics problem.

24. The method as claimed in claim 13, wherein one or more developed solutions are received and subsequently analyzed for selecting a solution from the developed solutions, based on a filtering technique, for resolving the data analytics problem.

25. A computer program product comprising:
a non-transitory computer-readable medium having computer-readable program code stored thereon, the computer-readable program comprising instructions that, when executed by the processor, causes the processor to:
render multiple standard use cases associated with one or more data analytics problems, wherein a standard use case is flagged from amongst the multiple standard use cases for analysis;
analyze the flagged standard use case based on a corresponding set of algorithms from a pre-defined set of algorithms for determining a sub-category of the standard use case;
perform a check to determine availability of an in-built solution for solving the one or more data analytics problems of the determined sub-category of the standard use case based on the corresponding set of algorithms from the pre-defined set of algorithms; and
generate an alert for development of one or more solutions to the problems related to the determined sub-category of the standard use case if the built-in solution is not found, wherein a solution is received from external developed solutions in response to the alert.
